(19) United States
(12) Patent Application Publication
(10) Pub. No.: US 2026/0211527 A1
(43) Pub. Date: Jul. 23, 2026

(54) TOUCH PROCESSING DEVICE, DISPLAY DEVICE AND TOUCH PROCESSING METHOD

(71) Applicant: Guangzhou China Star Optoelectronics Semiconductor Display Technology Co., LTd., Guangzhou (CN)

(72) Inventors: Shaochuan HAN, Guangzhou (CN); Jiaojian WANG, Guangzhou (CN)

(73) Assignee: Guangzhou China Star Optoelectronics Semiconductor Display Technology Co., LTd., Guangzhou (CN)

(21) Appl. No.: 19/096,308

(22) Filed: Mar. 31, 2025

(30) Foreign Application Priority Data
Jan. 17, 2025 (CN) 202510081489.8

(51) Int. Cl. G06F 3/044; G06F 3/0354; G06F 3/041

(52) U.S. Cl. CPC G06F 3/0442; G06F 3/03545; G06F 3/04162; G06F 3/04166; G06F 3/0441

(57) ABSTRACT

The present disclosure provides a touch processing device, a display device and a touch processing method. The touch processing device includes a mainboard, and a timing controller and a data processor connected to a control pin of the mainboard. The mainboard is configured to: output a target level to the timing controller and the data processor through the control pin. The timing controller is configured to: send a target communication timing between the touch processing device and an active pen to the mainboard when the target level is received. The data processor is configured to: process a data between the touch processing device and the active pen according to a target data format when the target level is received.

### CROSS-REFERENCE TO RELATED APPLICATION

The application claims priority to and the benefit of Chinese Patent Application No. 202510081489.8, filed on Jan. 17, 2025, the disclosure of which is incorporated herein by reference in its entirety.

### TECHNICAL FIELD

The present disclosure relates to display technologies, and in particular, to a touch processing device, a display device and a touch processing method.

### BACKGROUND

With the popularization of a display panel with a touch function, a capacitive pen has attracted more and more attention because it can simulate finger touch operations and has a thinner pen tip, which can achieve more accurate touch operations. To further improve human-computer interaction experience, an active pen technology emerges. However, at present, a single display device usually supports only active pens of a single protocol, which limits the expansibility and compatibility of the display device.

### SUMMARY

An embodiment of the present disclosure provides a touch processing device, including a mainboard, and a timing controller and a data processor connected to a control pin of the mainboard.

The mainboard is configured to: output a target level to the timing controller and the data processor through the control pin.

The timing controller is configured to: send a target communication timing between the touch processing device and an active pen to the mainboard when the target level is received.

The data processor is configured to: process a data between the touch processing device and the active pen according to a target data format when the target level is received.

Correspondingly, an embodiment of the present disclosure provides a display device, including a touch processing device as described above.

Correspondingly, an embodiment of the present disclosure provides a touch processing method, applied to a touch processing device, and the touch processing device including a mainboard, and a timing controller and a data processor connected to a control pin of the mainboard. The touch processing method includes:
outputting, by the mainboard, a target level to the timing controller and the data processor through the control pin;
sending, by the timing controller, a target communication timing between the touch processing device and an active pen to the mainboard when the target level is received; and
processing, by the data processor, a data between the touch processing device and the active pen according to a target data format when the target level is received.

### BRIEF DESCRIPTION OF THE DRAWINGS

FIG. 1 is a schematic diagram of a touch processing device according to an embodiment of the present disclosure;

FIG. 2 is a schematic diagram of another touch processing device according to an embodiment of the present disclosure; and

FIG. 3 is a schematic diagram of a touch processing method according to an embodiment of the present disclosure.

### DETAILED DESCRIPTION

Technical solutions in the embodiments of the present disclosure will be described below in conjunction with drawings in the embodiments of the present disclosure. The described technical solutions are merely for explaining and illustrating the ideas of the present disclosure, and should not be construed as limiting the scope of protection of the present disclosure.

In addition, “a plurality of” in the embodiments of the present disclosure refers to two or more. “First”, “second” and the like in the embodiments of the present disclosure are used to distinguish different technical features, and do not indicate any order, quantity, or importance.

The various embodiments provided in the present disclosure are similar, and features in different embodiments may be combined with each other.

The order of description of the following embodiments is not intended to limit the preferred order of the embodiments.

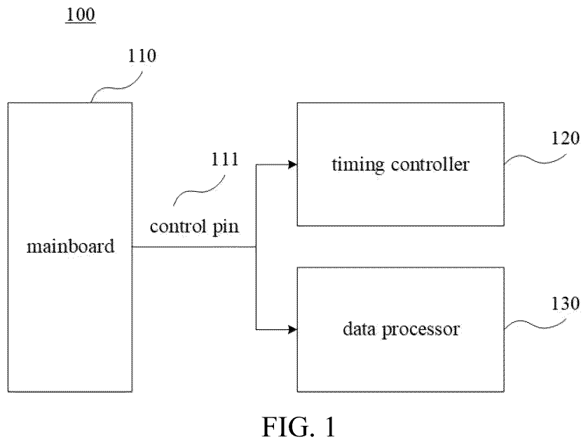

Referring to FIG. 1, FIG. 1 is a schematic diagram of a touch processing device according to an embodiment of the present disclosure. As shown in FIG. 1, the touch processing device 100 includes a mainboard 110, a timing controller 120, and a data processor 130. The timing controller 120 and the data processor 130 are respectively connected to a control pin 111 of the mainboard 110.

The mainboard 110 is configured to output a target level to the timing controller 120 and the data processor 130 through the control pin 111. The target level corresponds to a target transmission protocol, that is, the target level may indicate the target transmission protocol. The target transmission protocol may be a transmission protocol preset by a manufacturer, for example, the manufacturer may control the mainboard 110 to output the target level, to preset that the touch processing device 100 supports the target transmission protocol. Alternatively, the target transmission protocol may also be a transmission protocol detected in real time, for example, the mainboard 110 may detect the transmission protocol supported by an active pen in real time during user operation. In some embodiments, the mainboard 110 is further configured to: output the target level to the timing controller 120 and the data processor 130 through the control pin 111 when the target transmission protocol of the active pen is detected. Optionally, a level mapping data may be preset in the mainboard 110, and the level mapping data includes a mapping relationship between at least two groups of transmission protocols and levels, so that the mainboard 110 is configured to: determine the target level according to the level mapping data when the target transmission protocol of the active pen is detected; and output the target level to the timing controller 120 and the data processor 130 through the control pin 111.

The active pen is also referred to as an active capacitive pen, and has many advantages such as a higher touch accuracy, a built-in circuit, a pressure sensing function, etc. The transmission protocol of the active pen may include an uplink transmission protocol for an uplink data and/or a downlink transmission protocol for a downlink data. Optionally, the uplink transmission protocol includes but is not limited to a prefix field, an uplink command field, and a check field. The prefix field is configured to carry a pseudo random noise code (PRN code), and a parameter adjustment of the active pen or other functions may be performed by using the PRN code; the uplink command field may be configured to carry an uplink command sent by the touch processing device 100 to the active pen; and the check field may include one or more check bits, so as to carry check codes for checking. Optionally, the downlink transmission protocol includes but is not limited to a downlink information field and a pressure information field. The downlink information field may carry a downlink information sent by the active pen to the touch processing device 100; and the pressure information field may carry a pressure information between the active pen and a touch region of the display panel.

In practical applications, for active pens from different manufacturers, transmission protocols are usually different from each other. The target transmission protocol is not limited in the embodiments of the present disclosure. Optionally, the target transmission protocol includes but is not limited to any one of a Microsoft Pen Protocol (MPP), a Universal Stylus Initiative (USI), a Wacom Pen Protocol (WGP), and the like.

In some embodiments, the active pen may transmit a sensing data, and the touch processing device 100 may detect the sensing data transmitted by the active pen to establish a connection with the active pen. Therefore, the mainboard 110 is further configured to: determine the target transmission protocol of the active pen according to the sensing data when the sensing data of the active pen is received. Optionally, for different types of active pens, adapted to different transmission protocols, frequencies of the transmitted sensing data are different from each other. In that case, the mainboard 110 is further configured to: determine a frequency of the sensing data when the sensing data of the active pen is received; and determine the target transmission protocol according to the frequency of the sensing data. Of course, the transmission protocol supported by the active pen may also be determined according to other parameters of the sensing data, for example, according to a waveform, an energy and the like of the sensing data, which is not limited in the embodiment of the present disclosure.

The mainboard 110 outputs the target level to the timing controller 120 and the data processor 130 through the control pin 111, and the target level may indicate the target transmission protocol. In the embodiments of the present disclosure, the level mapping data may be preset in the mainboard 110, and in the level mapping data, different transmission protocols correspond to different levels. Exemplarily, when the target transmission protocol is the MPP, the mainboard 110 may output a first level through the control pin 111; when the target transmission protocol is the USI, the mainboard 110 may output a second level through the control pin 111; and when the target transmission protocol is the WGP, the mainboard 110 may output a third level through the control pin 111. Any two of the first level, the second level and the third level are different from each other. For example, the first level is a high level greater than zero, the second level is zero, and the third level is a low level less than zero.

The timing controller 120 is configured to: send a target communication timing between the touch processing device 100 and the active pen to the mainboard when the target level is received. The target communication timing corresponds to the target level. Optionally, a timing mapping data may be preset in the timing controller 120, and the timing mapping data includes a mapping relationship between at least two groups of levels and communication timings, so that the timing controller 120 is configured to: determine the target communication timing between the touch processing device 100 and the active pen according to the timing mapping data when the target level is received; and send the target communication timing to the mainboard.

The communication timing between the touch processing device 100 and the active pen refers to a timing and a sequence of the communication between the touch processing device 100 and the active pen. The communication timing may indicate when the touch processing device 100 sends the uplink data and when the active pen sends the downlink data, so as to ensure that the touch operation of the active pen is accurately detected and analyzed by the touch processing device 100, thereby achieving accurate coordinate positioning and pressure sensing. The communication timing may also involve a synchronization process, that is, the active pen and the touch processing device 100 need to establish a connection according to a signal transceiving timing and a period agreed in the transmission protocol, so as to realize an acquisition of the coordinate signal of the active pen by the touch processing device 100.

The data processor 130 is configured to: process a data between the touch processing device and the active pen according to a target data format when the target level is received. The target data format corresponds to the target level. Optionally, a format mapping data may be preset in the data processor 130, and the format mapping data includes a mapping relationship between at least two groups of levels and data formats, so that the data processor 130 is configured to: determine the target data format according to the format mapping data when the target level is received; and process the data between the touch processing device 100 and the active pen according to the target data format.

The data format includes a number of filled pits. The number of the filled pits refers to a specific number of signals sent according to the transmission protocol when the active pen sends the data to the touch processing device 100, or may also be referred to as a coding, so that the touch processing device 100 can recognize and analyze the data from the active pen. Generally, the number of the filled pits includes information such as a coordinate positioning, a pressure coding and the like, which ensures the integrity and correctness of the data.

In conclusion, in a touch processing device provided by the embodiments of the present disclosure, a control pin is added to a mainboard, and a timing controller and a data processor are respectively connected to the control pin of the mainboard. The main board sends a target level to the timing controller and the data processor respectively through the control pin. When the timing controller receives the target level, the timing controller invokes a target communication timing corresponding to the target level. When the data processor receives the target level, the data processor invokes a target data format corresponding to the target level. The level output by the control pin is used to invoke a corresponding communication timing and a data format, so that different levels may invoke different communication timings and data formats, to adapt to a plurality of transmission protocols of active pens, helping the touch processing device support active pens for different transmission protocols, thereby improving the expansibility and compatibility of the touch processing device.

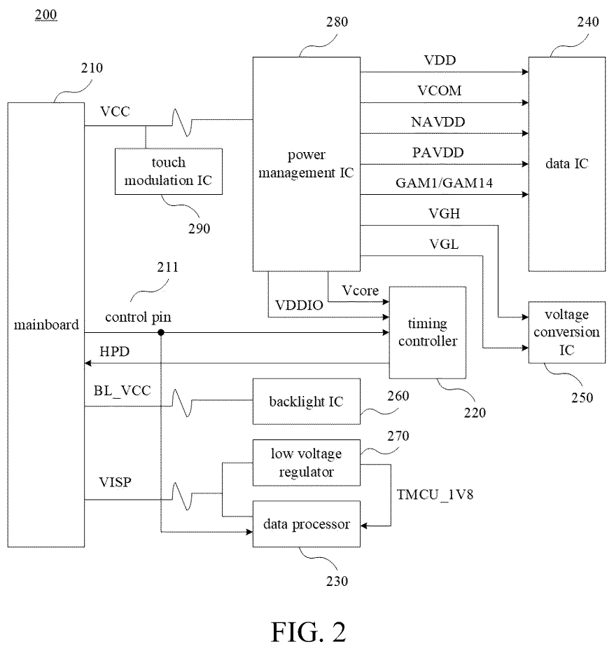

Referring to FIG. 2, FIG. 2 is a schematic diagram of another touch processing device according to an embodiment of the present disclosure. As shown in FIG. 2, the touch processing device 200 includes: a mainboard 210, a timing controller 220, and a data processor 230. The timing controller 220 and the data processor 230 are respectively connected to a control pin 211 of the mainboard 210. In addition, the touch processing device 200 further includes a data IC 240, a voltage conversion IC 250, a backlight IC 260, a low voltage regulator 270, a power management IC 280, and a touch modulation IC 290.

The timing controller 220, short for a TCON, is configured to generate communication timings adapted to different transmission protocols. The data processor 230, also referred to as a touch microcontroller (TMCU), is configured to process the data between the touch processing device 200 and the active pen. The data IC 240, also referred to as a source integrated circuit (SD IC), is configured to decode the data sent by the timing controller 220 and convert the data into a grayscale voltage. The voltage conversion IC 250, also referred to as a level shift integrated circuit (LS IC), is configured to output a driving waveform required by a gate driver on array (GOA). The backlight IC 260, also referred to as a backlight integrated circuit (BL IC), is configured to provide a voltage for the backlight. The low voltage regulator 270, also referred to as a low dropout regulator (LDO), is configured to provide a voltage for the data processor 230. The power management IC 280, also referred to as a power management integrated circuit (PMIC), is configured to provide voltages for another ICs. The touch modulation IC 290, also referred to as a touch modulation integrated circuit (TMIC), is configured to generate a modulation waveform.

Based on the aforementioned touch processing device, correspondingly, an embodiment of the present disclosure further provides a display device. The display device includes a touch processing device and a display panel with a touch function. The touch processing device may be the touch processing device shown in FIG. 1 or FIG. 2.

The touch processing device includes a mainboard, and a timing controller and a data processor connected to a control pin of the mainboard. The mainboard is configured to: output a target level to the timing controller and the data processor through the control pin. The timing controller is configured to: send a target communication timing between the touch processing device and an active pen to the mainboard when the target level is received. The data processor is configured to: process a data between the touch processing device and the active pen according to a target data format when the target level is received.

In some embodiments, the timing controller is configured to: determine the target communication timing between the touch processing device and the active pen according to a timing mapping data when the target level is received; and send the target communication timing to the mainboard. The timing mapping data includes a mapping relationship between at least two groups of levels and communication timings.

In some embodiments, the data processor is configured to: determine the target data format according to a format mapping data when the target level is received; and process the data between the touch processing device and the active pen according to the target data format. The format mapping data includes a mapping relationship between at least two groups of levels and data formats.

In some embodiments, the mainboard is further configured to: output the target level to the timing controller and the data processor through the control pin when a target transmission protocol of the active pen is detected.

In some embodiments, the mainboard is further configured to: determine the target level according to a level mapping data when the target transmission protocol of the active pen is detected; and output the target level to the timing controller and the data processor through the control pin. The level mapping data includes a mapping relationship between at least two groups of transmission protocols and levels.

In some embodiments, the mainboard is further configured to: determine the target transmission protocol according to a sensing data when the sensing data of the active pen is received.

In some embodiments, the mainboard is further configured to: determine a frequency of the sensing data when the sensing data of the active pen is received; and determine the target transmission protocol according to the frequency of the sensing data.

For each component and corresponding beneficial effects in the above touch processing device of the display device, reference may be made to the above detailed description of the touch processing device, and details are not described herein.

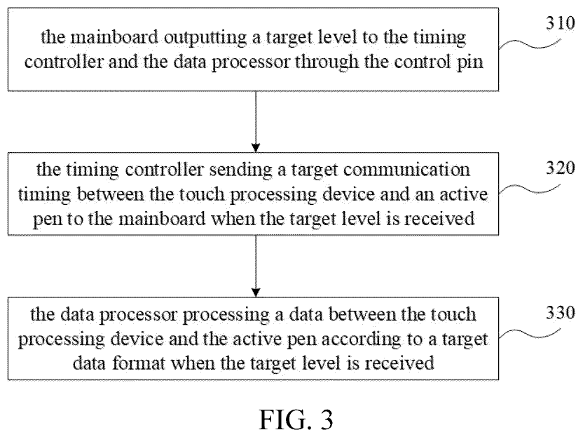

Based on the aforementioned touch processing device, correspondingly, an embodiment of the present disclosure further provides a touch processing method. The touch processing method may be applied to the aforementioned touch processing device. Referring to FIG. 3, the touch processing method includes the following steps:
step 310: the mainboard outputting a target level to the timing controller and the data processor through the control pin;
step 320: the timing controller sending a target communication timing between the touch processing device and an active pen to the mainboard when the target level is received; and
step 330: the data processor processing a data between the touch processing device and the active pen according to a target data format when the target level is received.

In some embodiments, the aforementioned step 320 includes: the timing controller determining the target communication timing between the touch processing device and the active pen according to a timing mapping data when the target level is received; and the timing controller sending the target communication timing to the mainboard. The timing mapping data includes a mapping relationship between at least two groups of levels and communication timings.

In some embodiments, the aforementioned step 330 includes: the data processor determining the target data format according to a format mapping data when the target level is received; and the data processor processing the data between the touch processing device and the active pen according to the target data format. The format mapping data includes a mapping relationship between at least two groups of levels and data formats.

In some embodiments, the aforementioned step 310 includes: the mainboard outputting the target level to the timing controller and the data processor through the control pin when a target transmission protocol of the active pen is detected.

In some embodiments, the aforementioned step 310 includes: the mainboard determining the target level according to a level mapping data when the target transmission protocol of the active pen is detected; and the mainboard outputting the target level to the timing controller and the data processor through the control pin. The level mapping data includes a mapping relationship between at least two groups of transmission protocols and levels.

In some embodiments, the aforementioned touch processing method further includes: the mainboard determining the target transmission protocol according to a sensing data when the sensing data of the active pen is received.

In some embodiments, the aforementioned touch processing method further includes: the mainboard determining a frequency of the sensing data when the sensing data of the active pen is received; and the mainboard determining the target transmission protocol according to the frequency of the sensing data.

For specific implementations and corresponding beneficial effects of the above operations, reference may be made to the above detailed description of the touch processing device, and details are not described herein.

The present disclosure has been described in detail with reference to a touch processing device, a display device and a touch processing method provided in the embodiments of the present disclosure. Specific examples are used herein to illustrate the principles and embodiments of the present disclosure. The description of the above embodiments is merely intended to help understand the technical solutions and the core idea of the present disclosure. At the same time, those skilled in the art may make modifications to the specific implementation modes and applying ranges based on concepts disclosed herein. In summary, the content of the description should not be construed as limiting the scope of the present disclosure.

1. A touch processing device, comprising a mainboard, a timing controller and a data processor connected to a control pin of the mainboard,
wherein the mainboard is configured to: determine a target level in response to reception of sensing data transmitted by an active pen, and output the target level to the timing controller and the data processor through the control pin;
the timing controller is configured to: send a target communication timing for a communication between the touch processing device and the active pen to the mainboard in response to reception of the target level and
the data processor is configured to: process data of the communication between the touch processing device and the active pen according to a target data format in response to reception of the target level.

2. The touch processing device according to claim 1, wherein the timing controller is further configured to:
determine the target communication timing for the communication between the touch processing device and the active pen according to timing mapping data in response to reception of the target level; and
send the target communication timing to the mainboard,
wherein the timing mapping data comprises at least two mapping relationships, each mapping relationship being between a level and a communication timing.

3. The touch processing device according to claim 1, wherein the data processor is further configured to:
determine the target data format according to format mapping data in response to reception of the target level; and
process the data of the communication between the touch processing device and the active pen according to the target data format,
wherein the format mapping data comprises at least two mapping relationships, each mapping relationship being between a level and a data format.

4. The touch processing device according to claim 1, wherein the mainboard is further configured to:
output the target level to the timing controller and the data processor through the control pin in response to detection of a target transmission protocol of the active pen.

5. The touch processing device according to claim 4, wherein the mainboard is further configured to:
determine the target level according to level mapping data in response to detection of the target transmission protocol of the active pen; and
output the target level to the timing controller and the data processor through the control pin,
wherein the level mapping data comprises at least two mapping relationships, each mapping relationship being between a level and a transmission protocol.

6. The touch processing device according to claim 4, wherein the mainboard is further configured to:
determine the target transmission protocol according to the sensing data in response to reception of the sensing data.

7. The touch processing device according to claim 6, wherein the mainboard is further configured to:
determine a frequency of the sensing data in response to reception of the sensing data; and
determine the target transmission protocol according to the frequency of the sensing data.

8. A display device, comprising a touch processing device and a display panel with a touch function,
wherein the touch processing device comprises: a mainboard, a timing controller and a data processor connected to a control pin of the mainboard;
the mainboard is configured to: determine a target level in response to reception of sensing data transmitted by an active pen, and output the target level to the timing controller and the data processor through the control pin;
the timing controller is configured to: send a target communication timing for a communication between the touch processing device and the active pen to the mainboard in response to reception of the target level; and
the data processor is configured to: process data of the communication between the touch processing device and the active pen according to a target data format in response to reception of the target level.

9. The display device according to claim 8, wherein the timing controller is further configured to:
determine the target communication timing for the communication between the touch processing device and the active pen according to timing mapping data in response to reception of the target level; and
send the target communication timing to the mainboard,
wherein the timing mapping data comprises at least two mapping relationships, each mapping relationship being between a level and a communication timing.

10. The display device according to claim 8, wherein the data processor is further configured to:
determine the target data format according to format mapping data in response to reception of the target level; and
process the data of the communication between the touch processing device and the active pen according to the target data format,
wherein the format mapping data comprises at least two mapping relationships, each mapping relationship being between a level and a data format.

11. The display device according to claim 8, wherein the mainboard is further configured to:
output the target level to the timing controller and the data processor through the control pin in response to detection of a target transmission protocol of the active pen.

12. The display device according to claim 11, wherein the mainboard is further configured to:
determine the target level according to level mapping data in response to detection of the target transmission protocol of the active pen; and
output the target level to the timing controller and the data processor through the control pin,
wherein the level mapping data comprises at least two mapping relationships, each mapping relationship being between a level and a transmission protocol.

13. The display device according to claim 11, wherein the mainboard is further configured to:
determine the target transmission protocol according to the sensing data in response to reception of the sensing data.

14. A touch processing method, applied to a touch processing device, and the touch processing device comprising a mainboard, a timing controller and a data processor connected to a control pin of the mainboard, wherein the touch processing method comprises:
determining, by the mainboard, a target level in response to reception of sensing data transmitted by an active pen;
outputting, by the mainboard, the target level to the timing controller and the data processor through the control pin;
sending, by the timing controller, a target communication timing for a communication between the touch processing device and the active pen to the mainboard in response to reception of the target level; and
processing, by the data processor, data of the communication between the touch processing device and the active pen according to a target data format in response to reception of the target level.

15. The touch processing method according to claim 14, wherein sending, by the timing controller, the target communication timing for the communication between the touch processing device and the active pen to the mainboard in response to reception of the target level comprises:
determining, by the timing controller, the target communication timing between the touch processing device and the active pen according to timing mapping data in response to reception of the target level; and
sending, by the timing controller, the target communication timing to the mainboard,
wherein the timing mapping data comprises at least two mapping relationships, each mapping relationship being between a level and a communication timing.

16. The touch processing method according to claim 14, wherein processing, by the data processor, the data of the communication between the touch processing device and the active pen according to the target data format in response to reception of the target level comprises:
determining, by the data processor, the target data format according to format mapping data in response to reception of the target level; and
processing, by the data processor, the data of the communication between the touch processing device and the active pen according to the target data format,
wherein the format mapping data comprises at least two mapping relationships, each mapping relationship being between a level and a data format.

17. The touch processing method according to claim 14, wherein outputting, by the mainboard, the target level to the timing controller and the data processor through the control pin comprises:
outputting, by the mainboard, the target level to the timing controller and the data processor through the control pin in response to detection of a target transmission protocol of the active pen.

18. The touch processing method according to claim 17, wherein outputting, by the mainboard, the target level to the timing controller and the data processor through the control pin in response to detection of the target transmission protocol of the active pen comprises:
determining, by the mainboard, the target level according to level mapping data in response to detection of the target transmission protocol of the active pen; and
outputting, by the mainboard, the target level to the timing controller and the data processor through the control pin,
wherein the level mapping data comprises at least two mapping relationships, each mapping relationship being between a level and a transmission protocol.

19. The touch processing method according to claim 17, wherein the touch processing method further comprises:
determining, by the mainboard, the target transmission protocol according to the sensing data in response to reception of the sensing data.

20. The touch processing method according to claim 19, wherein determining, by the mainboard, the target transmission protocol according to the sensing data in response to reception of the sensing data comprises:
determining, by the mainboard, a frequency of the sensing data in response to reception of the sensing data; and
determining, by the mainboard, the target transmission protocol according to the frequency of the sensing data.
